(19) United States
(12) Patent Application Publication
(10) Pub. No.: US 2014/0115692 A1
(43) Pub. Date: Apr. 24, 2014

(54) METHOD OF PROTECTING USER AND ELECTRONIC DEVICE THEREFOR

(71) Applicant: Samsung Electronics Co. Ltd., Suwon-si (KR)

(72) Inventor: Sang-Kyun LEE, Gumi-si (KR)

(73) Assignee: Samsung Electronics Co. Ltd., Suwon-si (KR)

(21) Appl. No.: 14/055,004

(22) Filed: Oct. 16, 2013

(30) Foreign Application Priority Data
Oct. 24, 2012 (KR) 10-2012-0118295

(51) Int. Cl. G06F 21/31

(52) U.S. Cl. CPC G06F 21/31
USPC 726/16

(57) ABSTRACT

A method and apparatus for recognizing a user in an electronic device and automatically controlling an output value of the electronic device is provided. The method includes detecting user related data using at least one sensor, determining whether the user is a user who is previously registered in the electronic device using the detected user related data, and automatically adjusting at least one output value of the electronic device when the user is determined as the user who is previously registered in the electronic device, wherein at least the one sensor includes at least one of a camera sensor, a touch sensor, and a microphone sensor.

### CROSS-REFERENCE TO RELATED APPLICATION(S)

This application claims the benefit under 35 U.S.C. §119(a) of a Korean patent application filed on Oct. 24, 2012 in the Korean Intellectual Property Office and assigned Serial No. 10-2012-0118295, the entire disclosure of which is hereby incorporated by reference.

### TECHNICAL FIELD

The present disclosure relates to output value control of an electronic device. More particularly, the present disclosure relates to a method for recognizing a user and for controlling an output value and the electronic device thereof.

### BACKGROUND

Recently, as a result of the increasing demand and development of electronic devices such as smart phones and tablet Personal Computers (PCs), such electronic devices that are capable of performing wireless voice communication and exchanging information have become necessities of life. As described above, as the electronic devices have gradually become more popular, demand for the electronic devices among children has also been increased. There exist children who there are introduced to such electronic devices from very early ages. However, most children that encounter electronic devices do not have their own individual electronic devices. Rather, children that encounter electronic devices often encounter electronic devices of the child's guardians. Herein, when a child uses an electronic device of the child's guardian alone, the child user causes an error in operation of the electronic device or is exposed to excessive radio waves. For example, when a guardian is present around (e.g., in proximity of) the child, the guardian may set the guardian's electronic device to operate in a flight mode (e.g., in which the electronic device engages in no or very limited communication) and thereby protect the child from high radio waves. However, when a guardian is not present around the child, the child is exposed to excessive radio waves due to injudicious use of an electronic device of the guardian.

Particularly, because a Specific Absorption Rate (SAR) of children is higher than an SAR of adults (e.g., at a maximum of 1.5 times or more), a method of preventing the children from being excessively exposed to radio waves of the electronic device is needed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to solve at least the above-mentioned problems and/or disadvantages and to provide at least the advantages described below. Accordingly, an aspect of the present disclosure is to provide a method and apparatus for protecting a user in an electronic device.

Another aspect of the present disclosure is to a method and apparatus for recognizing a user in an electronic device.

Another aspect of the present disclosure is to provide a method and apparatus for determining a recognized user as a child in an electronic device.

Another aspect of the present disclosure is to provide a method and apparatus for adjusting an output radio wave value when a user is determined to be a child user in an electronic device.

In accordance with an aspect of the present disclosure, a method in an electronic device is provided. The method includes detecting user related data using at least one sensor, determining whether the user is a user who is previously registered in the electronic device using the detected user related data, and automatically adjusting at least one output value of the electronic device when the user is determined as the user who is previously registered in the electronic device, wherein at least the one sensor includes at least one of a camera sensor, a touch sensor, and a microphone sensor.

In accordance with another aspect of the present disclosure, an electronic device is provided. The electronic device includes at least one processor, a touch-sensitive display, at least one sensor, a memory, and at least one program, each of the at least one program is stored in the memory and is executed by each of the at least one processor, wherein each of the at least one program includes an instruction for detecting user related data using at least the one sensor, determining whether a user is a user who is previously registered in the electronic device using the detected user related data, and automatically adjusting at least one output value of the electronic device when the user is determined as the user who is previously registered in the electronic device, and wherein the at least one sensor includes at least one of a camera sensor, a touch sensor, and a microphone sensor.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a block diagram illustrating configuration of an electronic device for adjusting at least one output value according to an embodiment of the present disclosure;

FIG. 1B is a block diagram illustrating detailed configuration of a processor for adjusting at least one output value according to an embodiment of the present disclosure;

FIG. 2A is a flowchart illustrating a process of adjusting at least one output value according to a recognized user in an electronic device according to an embodiment of the present disclosure;

FIG. 2B is a block diagram illustrating an electronic device configured to adjust at least one output value according to a recognized user in the electronic device according to an embodiment of the present disclosure;

FIG. 3 is a flowchart illustrating a process of recognizing a user and adjusting at least one output value when executing an unlocking function in an electronic device according to an embodiment of the present disclosure;

FIG. 4 is a flowchart illustrating a process of recognizing a user and adjusting at least one output value when executing a video communication function in an electronic device according to an embodiment of the present disclosure;

FIG. 5 is a flowchart illustrating a process of recognizing a user and adjusting at least one output value when executing a voice communication function in an electronic device according to an embodiment of the present disclosure;

FIG. 6 is a flowchart illustrating a process of recognizing a user and adjusting at least one output value when detecting a touch in an electronic device according to an embodiment of the present disclosure;

FIG. 7 illustrates an example to previously store a face of a user to recognize the user in an electronic device according to an embodiment of the present disclosure;

FIG. 8 illustrates an example to previously store a voice of a user to recognize the user in an electronic device according to an embodiment of the present disclosure;

FIG. 9 illustrates an example to recognize a face of a user when executing an unlocking function in an electronic device according to an embodiment of the present disclosure;

FIG. 10 illustrates an example to recognize a face of a user when executing a video communication function in an electronic device according to another embodiment of the present disclosure;

FIG. 11 illustrates an example to recognize a voice of a user when executing a voice communication function in an electronic device according to an embodiment of the present disclosure;

FIG. 12 illustrates an example to verify a size of a touch when detecting the touch in an electronic device according to an embodiment of the present disclosure; and

FIG. 13 illustrates an example to set a child protection menu in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, an electronic device include any one of a mobile communication terminal having a camera, a smart phone, a tablet PC, a digital camera, a Moving Picture Experts Group (MPEG) layer 3 (MP3) player, a navigation device, a laptop computer, a netbook, a handheld e-book, a Portable/Personal Multimedia Player (PMP), a Personal Digital Assistant (PDA), a portable game console, a computer, a television, a refrigerator, an air conditioner, and the like.

According to various embodiments of the present disclosure, an electronic device may determine whether a current user corresponds to a child or not a child (e.g., an adult, or the like) and based on such a determination, the electronic device may adjust at least one output of the electronic device (e.g., volume, display brightness, transmission power, or the like). For example, if the current user is determined to be a child, a value of the at least one output may be reduced. In contrast, if the current user is determined not to be a child, the values of the at least one output may be adjusted to an applicable output value for the current user. For example, if the output values were previously reduced because a child was using the device, a value of at least one output may be increased to a setting corresponding to a user that is not a child (e.g., the setting of the at least one output for use by a child may be negated or otherwise cancelled).

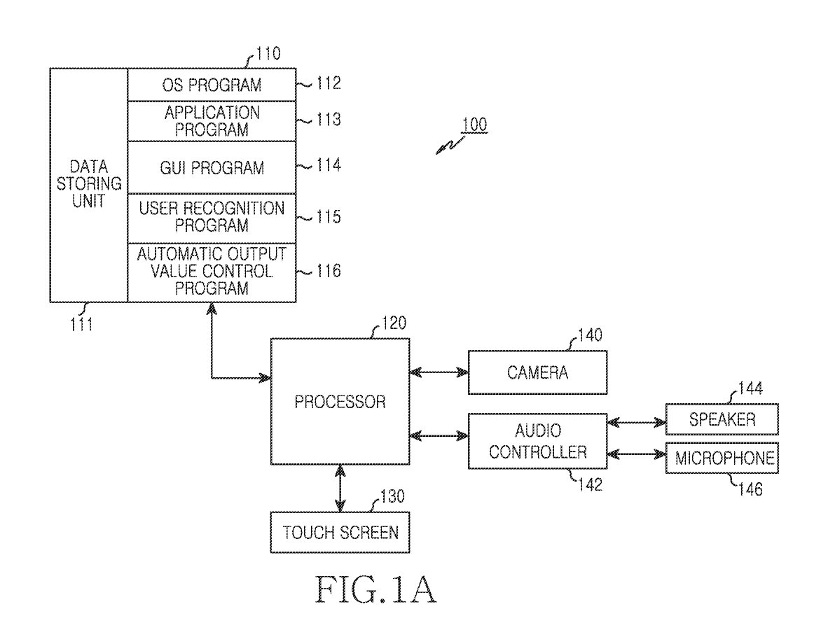

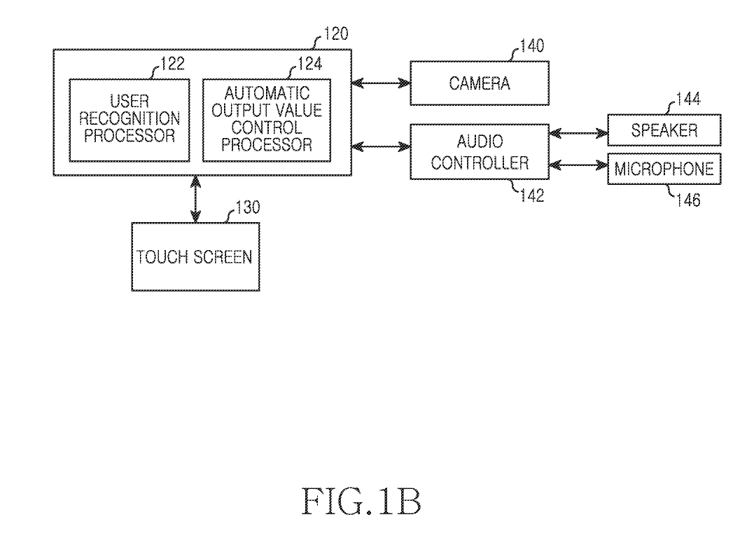

FIG. 1A is a block diagram illustrating configuration of an electronic device for adjusting at least one output value according to an embodiment of the present disclosure.

Referring to FIG. 1A, the electronic device 100 includes a memory 110, a processor 120, a touch screen 130, a camera 140, and an audio controller 142. The memory 110 and the processor 120 may be configured as a plurality of memories and a plurality of processors, respectively.

The memory 110 includes a data storing unit 111, an Operating System (OS) program 112, an application program 113, a Graphic User Interface (GUI) program 114, a user recognition program 115, an automatic output value adjustment program 116, and the like. According to various embodiments of the present disclosure, the programs which are software components may be expressed in a set of instructions. Accordingly, the programs may be expressed in an instruction set. According to various embodiments of the present disclosure, the programs may also be expressed in modules.

The memory 110 may store one or more programs including instructions for performing various embodiments of the present disclosure.

The data storing unit 111 stores data generated while a function corresponding to the program stored in the memory 110 is executed. The data storing unit 111 according to an embodiment of the present disclosure may store face data and voice data of a child to determine whether a user is the child. In addition, the data storing unit 111 may store an output value or an output adjustment value of the electronic device 100 for a child user. For example, when the user is determined to be the child, the data storing unit 111 may store an output adjust value for the child user as 1 dB to automatically turn down (e.g., reduce) transmission power by 1 dB. According to various embodiments of the present disclosure, when a touch is detected, the data storing unit 111 may store a threshold size value of the touch for determining whether the user is the child.

The OS program 112 (e.g., embedded OS such as Windows, Linux, Darwin, RTXC, UNIX, OS X, or VxWorks) includes several software components for controlling a general system operation. For example, control of the general system operation means memory management and control, storage hardware (device) control and management, power control and management, and the like. The OS program 112 also performs a function for smoothly communicating between several hardware components (devices) and software components (programs).

The application program 113 includes applications, such as a browser function application, an email function application, a message function application, a word processing function application, an address book function application, a widget function application, a Digital Right Management (DRM) function application, a voice recognition function application, a voice copy function application, a position determining function application, a location based service function application, a call function application, and the like.

The GUI program 114 includes at least one software component for providing a UI using graphics between the user and the electronic device 100. For example, the GUI program 114 includes at least one software component for displaying UI information on the touch screen 130. The GUI program 114 according to an embodiment of the present disclosure includes an instruction for displaying a menu or an icon for setting a mode of the electronic device 100 to a child protection mode.

The user recognition program 115 may store at least one child user data in the memory 110. In more detail, the user recognition program 115 may detect user data through at least one sensor and determine and store the detected data as child user data. Herein, the child user data includes at least one of face data and voice data of a child user. For one example, the user recognition program 115 may detect user face data through a camera sensor (not shown) and determine the detected user face data as child face data. For another example, the user recognition program 115 may detect user voice data through a microphone sensor (not shown) and determine the detected user voice data as child voice data. When user input is detected in a waiting mode state, the user recognition program 115 verifies whether a child protection mode is set. When the child protection mode is set, the user recognition program 115 may drive at least one sensor to detect at least one of user face data, user voice data, and touch data. For example, if the user recognition program 115 verifies that the child protection mode is set when a push of a home button is detected in a waiting mode state, the user recognition program 115 may drive at least one of a camera sensor, a microphone sensor, and a touch sensor.

When the electronic device 100 is set to a child protection mode, the user recognition program 115 may recognize the user through at least one sensor and verify whether the recognized user is a child user. For example, when the electronic device 100 is set to the child protection mode, the user recognition program 115 may drive at least one sensor automatically, detect user related data, and verify whether the detected user related data is identical to previously stored child user data. Herein, at least the one sensor includes at least one of a camera sensor, a touch sensor, and a microphone sensor. For example, when the electronic device 100 is set to the child protection mode, the user recognition program 115 may automatically drive at least one of the camera sensor and the microphone sensor and verify whether detected user related data is identical to previously stored child user data. If the detected user related data is identical to the child user data, the user recognition program 115 may control the automatic output value control program 116 to adjust at least one output value. In contrast, when the detected user related data is not identical to the child user data, the user recognition program 115 operates in a normal mode for performing a normal function of the electronic device 100 according to input data.

In addition, when a specific event is generated in a state where the electronic device 100 is set to the child protection mode, the user recognition program 115 may recognize the user through at least one sensor and verify whether the recognized user is a child user. For example, if the specific event is generated in the state in which the electronic device 100 is set to the child protection mode, the user recognition program 115 may automatically drive at least one sensor, detect user related data, and verify whether the detected user related data is identical to previously stored child user data. For one example, when an unlocking function is executed in the state where the electronic device 100 is set to the child protection mode, the user recognition program 115 may drive a camera sensor automatically, detect user face data, and verify whether the detected user face data is identical to previously stored child face data. For another example, when a video communication function is executed in the state in which the electronic device 100 is set to the child protection mode, the user recognition program 115 may automatically drive the camera sensor, detect user face data, and verify whether the detected user face data is identical to previously stored child face data. For another example, when a voice communication function is executed in the state in which the electronic device 100 is set to the child protection mode, the user recognition program 115 may automatically drive a microphone sensor, detect user voice data, and verify whether the detected user voice data is identical to previously stored child voice data. If the detected user related data is identical to the child user data, the user recognition program 115 may control the automatic output value adjustment program 116 to adjust at least one output value. In contrast, if the detected user related data is not identical to the child user data, the user recognition program 115 may perform a normal function of the electronic device 100 according to input data.

In addition, when a touch is detected in the state in which the electronic device 100 is set to the child protection mode, if an area of the detected touch is smaller than a previously stored threshold area, the user recognition program 115 may automatically drive at least one sensor, detect user related data, and verify whether the detected user related data is identical to previously stored child user data.

When the user is determined to be identical to a previously registered user by the user recognition program 115, the automatic output value adjustment program 116 automatically adjusts at least one output value of the electronic device 100. Herein, at least the one output value means at least one of a sound output value, a power output value, and a transmission output value to an external device. When the user is determined to be identical to the previously registered user by the user recognition program 115, the automatic output value adjustment program 116 may adjust a level (volume) of a sound output through the speaker 144 to be lowered by predetermined volume. When the user is determined to be identical to the previously registered user by the user recognition program 115, the automatic output value adjustment program 116 may turn down (e.g., reduce) brightness of a screen output through the touch screen 130 darkly by reducing an amount of current supplied to a display panel. In addition, when the user is determined to be identical to the previously registered user by the user recognition program 115, the automatic output value adjustment program 116 may turn down strength (e.g., reduce) of radio waves output through the electronic device 100 by reducing transmission power of signals transmitted to an external device. For example, when the user is determined to be identical to the previously registered user by the user recognition program 115, the automatic output value adjustment program 116 may turn down (e.g., reduce) strength of radio waves output through the electronic device 100 about 0.4 kg/w by reducing more transmission power of signals transmitted to the external device than transmission power of a normal mode by about 1 dB to 2 dB. Accordingly, the automatic output value adjustment program 116 may reduce an amount of radio waves absorbed by the user of the electronic device 100. Herein, the transmission power of the normal mode may be transmission power determined based on technologies well known in the electronic device 100 during a state in which the child protection mode is not set, a state in which the child protection mode is set, or a state in which a user is not a child.

In addition, when the user is determined to be identical to a previously registered user by the user recognition program 115 in the state in which the electronic device 100 is set to the child protection mode, the automatic output value adjustment program 116 may further include an instruction for automatically stopping a call transmission and reception function of the electronic device 100. For one example, when the user is determined to be a child in the state in which the electronic device 100 is set to the child protection mode, the automatic output value adjustment program 116 may disregard a generated event although a call transmission event is generated by the user and not perform a call transmission function. As another example, when the user is determined to be a child in the state in which the electronic device 100 is set to the child protection mode, the automatic output value adjustment program 116 may automatically enter a flying mode (e.g., a flight mode, or airplane mode) and turn off all signal transmission and reception functions.

According to various embodiments of the present disclosure, the user recognition program 115 may store information relating to characteristics which may be used to determine whether a user is a child. For example, the user recognition program 115 may store information relating to inputs from various sensors which may be used to determine whether the use is a child. The characteristics may not be specific to any one child. Rather, the characteristics may applicable to (or common among) most (or all) children.

It is not shown in FIG. 1A, the processor 120 may include at least one processor and a peripheral interface. The processor 120 executes a specific program (instruction set) stored in the memory 110 and performs a plurality of specific functions corresponding to the program.

The touch screen 130 as a touch-sensitive display provides an interface for touch input/output between the electronic device 100 and the user. The touch screen 130 is a medium for detecting a touch through a touch sensor (not shown), transmitting the detected touch input to the electronic device 100, and visually providing output from the electronic device 100 to the user. For example, the touch screen 130 provides visual output based on text, graphics, and video to the user in response to touch input.

The touch screen 130 includes a touch sensing surface for detecting touch input of the user. The touch screen 130 detects touch input of the user by a haptic touch, a tactile touch, and/or a combination thereof. For example, a touch sensing point of the touch screen 130 corresponds to a width of a digit used in a touch on a touch sensing surface. The touch screen 130 may detect a touch by an external device such as a stylus pen through a touch sensing surface. The detected touch is converted into interaction corresponding to a user interface target (e.g., a soft key) displayed on the touch screen 130.

The touch screen 130 provides an interface for touch input/output between the electronic device 100 and the user. In more detail, the touch screen 130 is a medium for transmitting touch input of the user to the electronic device 100 and visually providing output from the electronic device 100 to the user. The touch screen 130 may use various display technologies, such as a Liquid Crystal Display (LCD) technology, a Light Emitting Diode (LED) technology, a Light emitting Polymer Display (LPD) technology, an Organic Light Emitting Diode (OLED) technology, an Active Matrix Organic Light Emitting Diode (AMOLED) technology, a Flexible LED (FLED) technology, and/or the like. The touch screen 130 according to an embodiment of the present disclosure is not limited to the touch screen using the above-identified display technologies. According to various embodiments of the present disclosure, the touch screen 130 may detect the start of a touch on a touch sensing surface, the movement of the touch, and/or the stop or end of the touch using several touch detection (or sensing) technologies such as capacitive, resistive, infrared, surface acoustic wave detection technologies, and/or the like. The touch screen 130 according to an embodiment of the present disclosure may detect a touch on a certain region thereof. According to various embodiments of the present disclosure, the touch screen 130 may display a menu or an icon for setting a mode of the electronic device 100 to a child protection mode.

The camera 140 includes camera related software components capable of performing camera related processes and functions. The camera 140 detects an image through a camera sensor (not shown) and transmits the detected image to the electronic device 100. When the electronic device 100 is set to the child protection mode, the camera 140 according to an embodiment of the present disclosure may be automatically driven and detect face data of the user. Herein, the camera 140 may be installed in a front surface and/or a rear surface. When the camera 140 is installed in the front surface and the rear surface, the camera 140 installed in the front surface may be automatically driven.

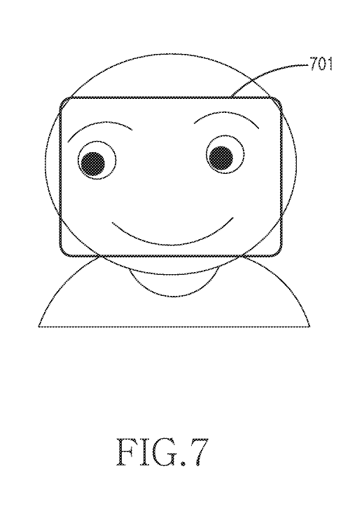

FIG. 7 illustrates an example to previously store a face of a user to recognize the user in an electronic device according to an embodiment of the present disclosure.

Referring to FIG. 7, the camera 140 may recognize a face region 701 of the user and detect data.

The audio controller 142 connects to a speaker 144 and a microphone 146 and performs an input and output function of an audio stream, such as a voice recognition function, a voice copy function, a digital recording function, a phone call function, and/or the like. For example, the audio controller 142 outputs an audio signal through the speaker 144 and receives a voice signal of the user through the microphone 146. The audio controller 142 receives a data stream through the processor 120, converts the received data stream into an electric stream, and transmits the converted electric stream to the speaker 144. The audio controller 142 receives a converted electric stream from the microphone 146, converts the received electric stream into an audio data stream, and transmits the converted audio data stream to the processor 120. The audio controller 142 may include an attachable and detachable earphone, headphone, or headset. The speaker 144 converts the electric stream received from the audio controller 142 into a sound wave to which people may listen and outputs the converted sound wave. The microphone 146 converts sound waves transmitted from people or other sound sources into electric streams. When the electronic device 100 is set to the child protection mode, the audio controller 142 according to an embodiment of the present disclosure may drive the microphone 146 automatically and detect voice data of the user. The audio controller 142 may output a sound adjusted by the automatic output value adjustment program 116 through the speaker 144.

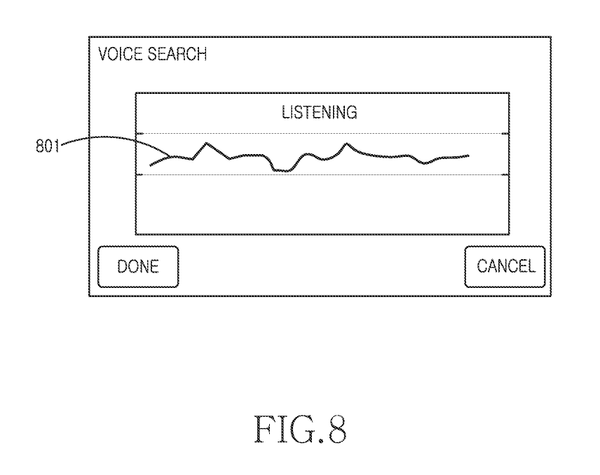

FIG. 8 illustrates an example to previously store a voice of a user to recognize the user in an electronic device according to an embodiment of the present disclosure.

Referring to FIG. 8, the audio controller 142 may receive voice data 801 of the user through the microphone 146.

FIG. 1B is a block diagram illustrating detailed configuration of a processor for adjusting at least one output value according to an embodiment of the present disclosure.

Referring to FIGS. 1A and 1B, the processor 120 may include a user recognition processor 122 and an automatic output value control processor 124.

The user recognition processor 122 may store at least one child user data in the memory 110. In more detail, the user recognition processor 122 may detect user data through at least one sensor and determine and store the detected data as child user data. Herein, the child user data includes at least one of face data and voice data of a child user. For one example, the user recognition processor 122 may detect user face data through a camera sensor (not shown) and determine the detected user face data as child face data. As another example, the user recognition processor 122 may detect user voice data through a microphone sensor (not shown) and determine the detected user voice data as child voice data. When user input is detected in a waiting mode state, the user recognition processor 122 verifies whether a child protection mode is set. When the child protection mode is set, the user recognition processor 122 may drive at least one sensor to detect at least one of user face data, user voice data, and touch data. If the user recognition processor 122 verifies that the child protection mode is set when a push of a home button is detected in a waiting mode state, the user recognition processor 122 may drive at least one of a camera sensor, a microphone sensor, and a touch sensor.

When the electronic device 100 is set to the child protection mode, the user recognition processor 122 may recognize the user through at least one sensor and verify whether the recognized user is a child user. For example, when the electronic device 100 is set to the child protection mode, the user recognition processor 122 may automatically drive at least one sensor, detect user related data, and verify whether the detected user related data is identical to previously stored child user data. Herein, at least the one sensor includes at least one of a camera sensor, a touch sensor, a microphone sensor, and/or the like. For example, when the electronic device 100 is set to the child protection mode, the user recognition processor 122 may automatically drive at least one of the camera sensor and the microphone sensor and verify whether detected user related data is identical to previously stored child user data. If the detected user related data is identical to the child user data, the user recognition processor 122 may control the automatic output value control processor 124 to adjust at least one output value. In contrast, when the detected user related data is not identical to the child user data, the user recognition processor 122 operates in a normal mode for performing a normal function of the electronic device 100 according to input data.

In addition, when a specific event is generated in a state in which the electronic device 100 is set to the child protection mode, the user recognition processor 122 may recognize the user through at least one sensor and verify whether the recognized user is a child user. For example, if the specific event is generated in the state in which the electronic device 100 is set to the child protection mode, the user recognition processor 122 may automatically drive at least one sensor, detect user related data, and verify whether the detected user related data is identical to previously stored child user data. For one example, when an unlocking function is executed in the state in which the electronic device 100 is set to the child protection mode, the user recognition processor 122 may drive a camera sensor automatically, detect user face data, and verify whether the detected user face data is identical to previously stored child face data. As another example, when a video communication function is executed in the state in which the electronic device 100 is set to the child protection mode, the user recognition processor 122 may automatically drive the camera sensor, detect user face data, and verify whether the detected user face data is identical to previously stored child face data. As another example, when a voice communication function is executed in the state in which the electronic device 100 is set to the child protection mode, the user recognition processor 122 may automatically drive a microphone sensor, detect user voice data, and verify whether the detected user voice data is identical to previously stored child voice data. If the detected user related data is identical to the child user data, the user recognition processor 122 may control the automatic output value adjustment processor 124 to adjust at least one output value. In contrast, if the detected user related data is not identical to the child user data, the user recognition processor 122 may perform a normal function of the electronic device 100 according to input data.

In addition, when a touch is detected in the state in which the electronic device 100 is set to the child protection mode, if an area of the detected touch is smaller than a previously stored threshold area, the user recognition processor 122 may automatically drive at least one sensor, detect user related data, and verify whether the detected user related data is identical to previously stored child user data.

When the user is determined to be identical to a previously registered user by the user recognition processor 122, the automatic output value adjustment processor 124 adjusts at least one output value of the electronic device 100 automatically. Herein, at least the one output value means at least one of a sound output value, a power output value, and a transmission output value to an external device. When the user is determined to be identical to the previously registered user by the user recognition processor 122, the automatic output value adjustment processor 124 may turn down (e.g., reduce) a level (volume) of a sound output through the speaker 144 to be lowered by predetermined volume. When the user is determined to be identical to the previously registered user by the user recognition processor 122, the automatic output value adjustment processor 124 may turn down (e.g., reduce) brightness of a screen output through the touch screen 130 darkly by reducing an amount of current supplied to a display panel. When the user is determined to be identical to the previously registered user by the user recognition processor 122, the automatic output value adjustment processor 124 may turn down (e.g., reduce) strength of radio waves output through the electronic device 100 by reducing transmission power of signals transmitted to an external device. For example, when the user is determined to be identical to the previously registered user by the user recognition processor 122, the automatic output value adjustment processor 124 may turn down (e.g., reduce) strength of radio waves output through the electronic device 100 by about 0.4 kg/w by reducing more transmission power of signals transmitted to the external device than transmission power of a normal mode by about 1 dB to 2 dB. Accordingly, the automatic output value adjustment processor 124 may reduce an amount of radio waves absorbed by the user of the electronic device 100. Herein, the transmission power of the normal mode may be transmission power determined based on technologies well known in the electronic device 100 during a state in which the child protection mode is not set, a state in which the child protection mode is set, or a state in which a user is not a child.

In addition, when the user is determined to be identical to a previously registered user by the user recognition processor 122 in the state in which the electronic device 100 is set to the child protection mode, the automatic output value adjustment processor 124 may further include an instruction for automatically stopping a call transmission and reception function of the electronic device 100. For one example, when the user is determined to be a child in the state in which the electronic device 100 is set to the child protection mode, the automatic output value adjustment processor 124 may disregard a generated event although a call transmission event is generated by the user and not perform a call transmission function. As another example, when the user is determined to be a child in the state in which the electronic device 100 is set to the child protection mode, the automatic output value adjustment processor 124 may enter a flying mode automatically and turn off all signal transmission and reception functions.

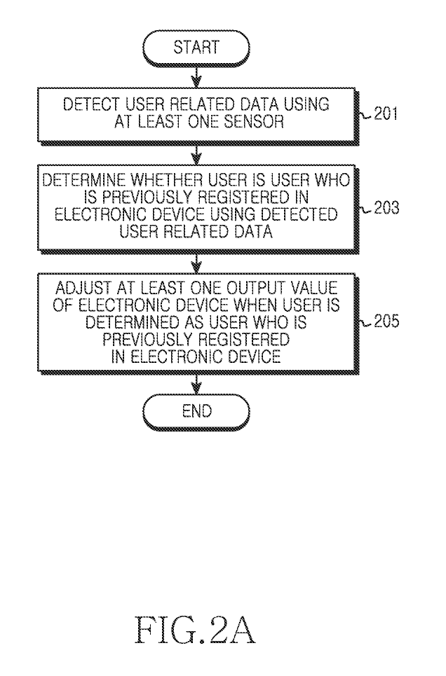

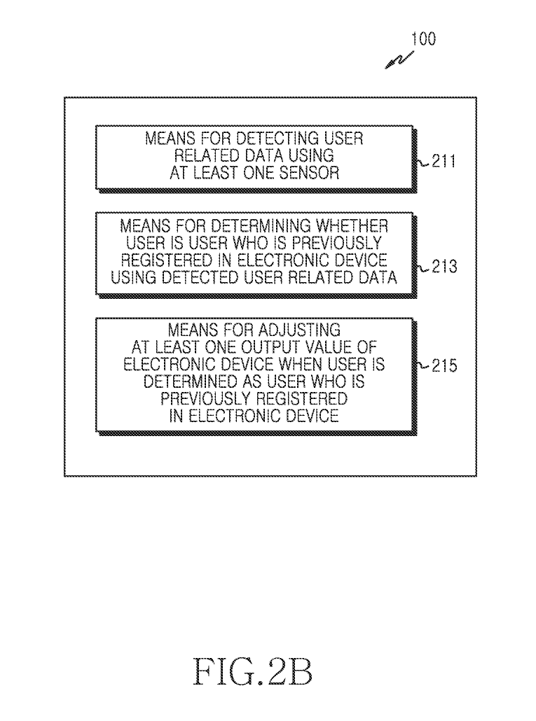

FIG. 2A is a flowchart illustrating a process of adjusting at least one output value according to a recognized user in an electronic device according to an embodiment of the present disclosure.

Referring to FIGS. 1A and 2A, at operation 201, the electronic device 100 detects user related data using at least one sensor. For example, the electronic device 100 may detect user face data through a camera sensor. As another example, the electronic device 100 may detect user voice data through a microphone sensor.

Thereafter, at operation 2013, the electronic device 100 determines whether a user is a user who is previously registered in the electronic device 100 using the detected user related data. Herein, when the user related data detected through at least the one sensor is identical (e.g., within a selected or predetermined confidence interval) to previously stored user data, the electronic device 100 may determine the corresponding user as the previously registered user. For example, when the user face data detected through the camera sensor is identical to the previously stored face data, the electronic device 100 may determine the corresponding user as a previously registered user. As another example, when the user voice data detected through the microphone sensor is identical to previously stored voice data, the electronic device 100 may determine the corresponding user as a previously registered user.

Thereafter, the electronic device 100 proceeds at operation 205 at which the electronic device 100 automatically adjusts at least one output value thereof when the user is determined to be the user who is previously registered therein. Herein, at least the one output value means at least one of a sound output volume value, a screen output brightness value, an output power value of a transmission signal to an external device, and/or the like. For example, when the user is determined to be the user who is previously registered in the electronic device 100, the electronic device 100 may automatically turn down (e.g., reduce) a level of a sound output through the speaker 144. As another example, when the user is determined to be the user who is previously registered in the electronic device 100, the electronic device 100 may automatically turn down brightness (e.g., reduce) of a screen output through the touch screen 130 (e.g., such that the screen output through the touch screen 130 is displayed darkly). As another example, when the user is determined to be the user who is previously registered in the electronic device 100, the electronic device 100 may automatically turn down (e.g., reduce) a level of output radio waves.

FIG. 2B is a block diagram illustrating an electronic device configured to at least one output value according to a recognized user in the electronic device according to an embodiment of the present disclosure.

Referring to FIGS. 1A and 2B, the electronic device 100 includes a means 211 for detecting user related data using at least one sensor. Herein, at least the one sensor includes at least one of a camera sensor, a touch sensor, a microphone sensor, and/or the like. Herein, when the camera 140 is installed in all of a front surface and a rear surface of the electronic device 100, the electronic device 100 may detect user related data using the camera 140 installed in the front surface.

In addition, the electronic device 100 includes a means 213 for determining whether a user is a user who is previously registered in the electronic device 100 using the detected user related data. Herein, the user related data includes at least one of user face data and user voice data. If the detected user related data is user face data, the electronic device 100 may compare the detected user face data with previously registered user face data using a well known video recognition algorithm and well known image recognition algorithms. If the detected user related data is user voice data, the electronic device 100 compares the detected user voice data with previously registered user voice data using well known voice recognition algorithms.

The electronic device 100 also includes means 215 for adjusting at least one output value of the electronic device 100 when the user is determined to be a user who is previously registered in the electronic device 100. Herein, at least the one output value means at least one of a sound output volume value, a screen output brightness value, an output power value of a transmission signal to an external device, and/or the like. For example, when the user is determined to be the user who is previously registered in the electronic device 100, the means 215 may automatically turn down (e.g., reduce) a level of a sound output through the speaker 144. As another example, when the user is determined to be the user who is previously registered in the electronic device 100, the means 215 may automatically turn down brightness (e.g., reduce) of a screen output through the touch screen 130 (e.g., such that the screen output through the touch screen 130 is displayed darkly). As another example, when the user is determined to be the user who is previously registered in the electronic device 100, the means 215 may automatically turn down (e.g., reduce) a level of output radio waves.

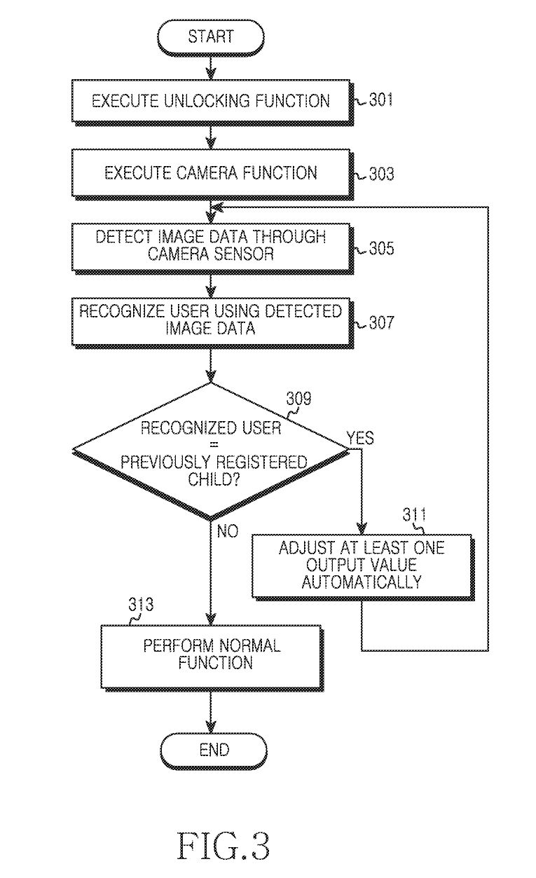

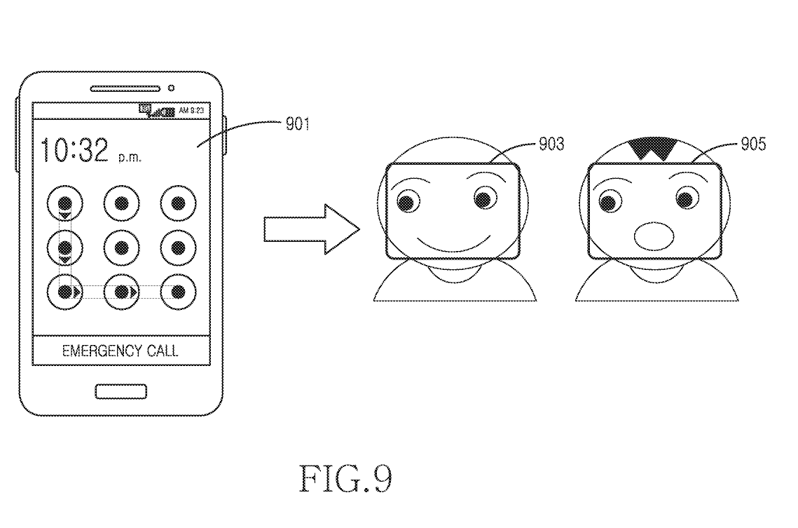

FIG. 3 is a flowchart illustrating a process of recognizing a user and adjusting at least one output value when executing an unlocking function in an electronic device according to an embodiment of the present disclosure. FIG. 9 illustrates an example to recognize a face of a user when executing an unlocking function in an electronic device according to an embodiment of the present disclosure.

Referring to FIGS. 1A, 3, and 9, at operation 301, an unlocking function is executed.

Thereafter, at operation 303, the electronic device 100 executes a camera function.

At operation 305, the electronic device 100 detects image data through a camera sensor.

At operation 307, the electronic device 100 recognizes a user using the detected image data. For example, the electronic device 100 acquires an image through the camera sensor and recognizes a user face region on the acquired image. Herein, the electronic device 100 may recognize a user face region using a well known video recognition algorithm and/or well known image recognition algorithms.

Thereafter, the electronic device 100 proceeds at operation 309 at which the electronic device 100 verifies whether the recognized user is identical to a previously registered child user. For example, the electronic device 100 recognizes a face of the user using the detected image data and verifies whether the recognized face data of the user is identical to previously stored face data of a child user. For example, as shown in FIG. 9, when an unlocking function 901 is executed, the electronic device 100 may recognize a face region 903 of the user through the camera sensor and verify whether data of the recognized face region 903 of the user is identical to data of a previously stored face region 905 of a child user.

If the electronic device 100 determines that the recognized user is identical to the previously registered child user at operation 309, then the electronic device 100 proceeds to operation 311 at which the electronic device 100 automatically adjusts at least one output value. Thereafter, the electronic device returns to operation 305. Herein, when the recognized user is determined to be the child user, the electronic device 100 may turn down (e.g., reduce) a level of an output sound to be lowered for the child user by a predetermined level. The electronic device 100 may turn down (e.g., reduce) brightness of an output screen darkly by reducing an amount of current supplied to a display panel. The electronic device 100 may turn down (e.g., reduce) strength of output radio waves by reducing transmission power for signals to be transmitted to an external device. In addition, when the recognized user is identical to a previously registered child user, the electronic device 100 may automatically stop a call transmission and reception function.

In contrast, when the recognized user is determined not to be identical to the previously registered child user at operation 309, then the electronic device 100 proceeds to operation 313 at which the electronic device 100 performs a normal function thereof, and ends the algorithm of FIG. 3. Herein, the normal function of the electronic device 100 corresponds to a general function of the electronic device 100, which operates according to user input.

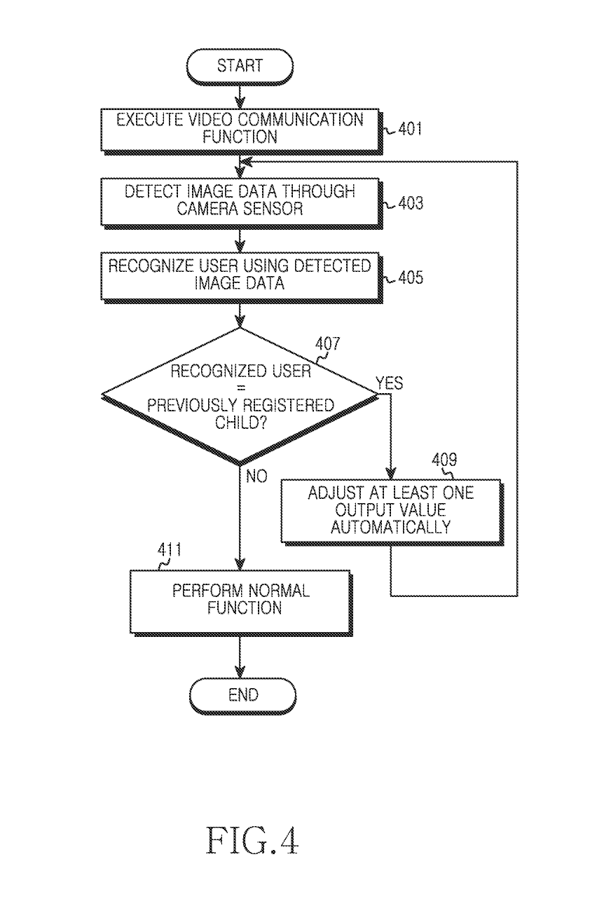

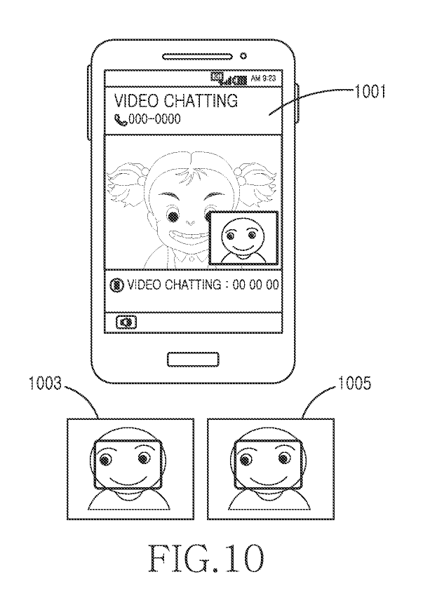

FIG. 4 is a flowchart illustrating a process of recognizing a user and adjusting at least one output value when executing a video communication function in an electronic device according to an embodiment of the present disclosure. FIG. 10 illustrates an example to recognize a face of a user when executing a video communication function in an electronic device according to another embodiment of the present disclosure.

Referring to FIGS. 1A, 4, and 10, at operation 401, the electronic device 100 executes a video communication function. Herein, the electronic device 100 drives a front camera automatically according as the video communication function is executed.

Thereafter, at operation 403, the electronic device 100 detects image data through a camera sensor.

At operation 405, the electronic device 100 recognizes a user using the detected image data. Herein, the electronic device 100 may recognize a user face region using a well known video recognition algorithm and well known image recognition algorithms.

At operation 407, the electronic device 100 verifies whether the recognized user is identical to a previously registered child user. For example, as shown in FIG. 10, when a video communication function 1001 is executed, the electronic device 100 may recognize a face region 1003 of the user through the camera sensor and verify whether data of the recognized face region 1003 of the user is identical to data of a previously stored face region 1005 of a child user.

If the electronic device 100 determines that the recognized user is identical to the previously registered child user at operation 407, then the electronic device 100 proceeds to operation 409 at which the electronic device 100 automatically adjusts at least one output value. Thereafter, the electronic device 100 returns to operation 403. Herein, the electronic device 100 may automatically adjust an output value of at least one of sound output, screen brightness output, radio wave output, and/or the like.

In contrast, if the electronic device 100 determines that the recognized user is not identical to the previously registered child user at operation 407, then the electronic device 100 proceeds to operation 411 at which the electronic device 100 performs a normal function thereof, and ends the algorithm of FIG. 4.

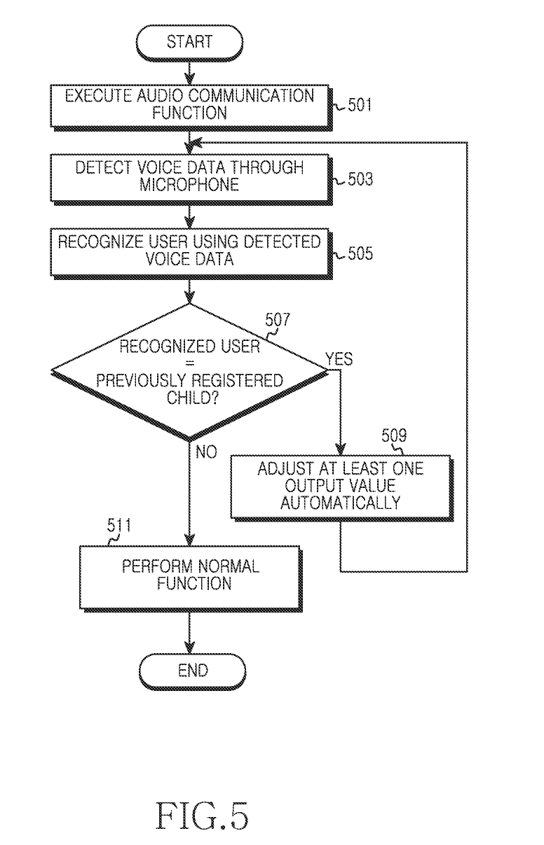

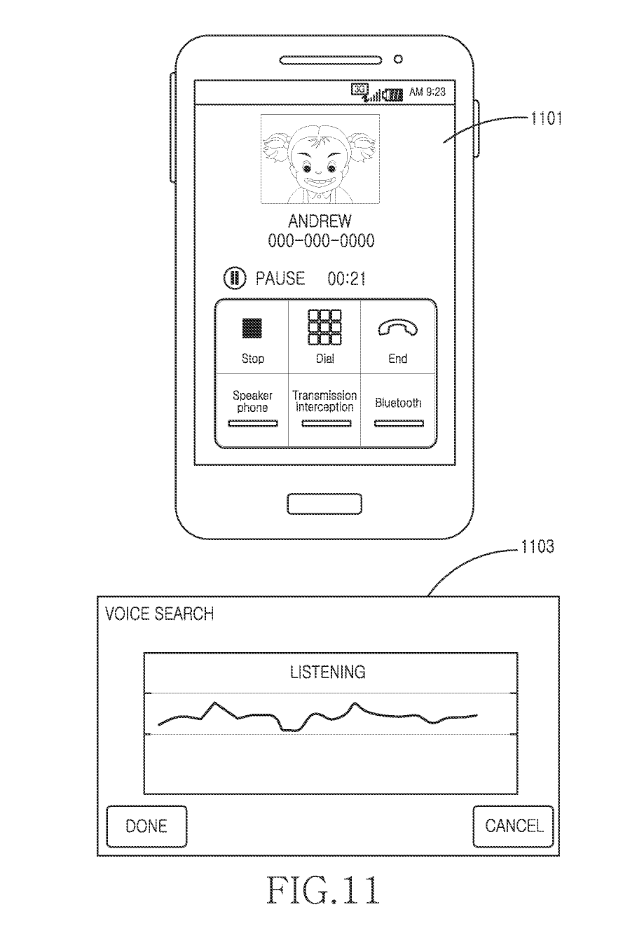

FIG. 5 is a flowchart illustrating a process of recognizing a user and adjusting at least one output value when executing a voice communication function in an electronic device according to an embodiment of the present disclosure. FIG. 11 illustrates an example to recognize a voice of a user when executing a voice communication function in an electronic device according to an embodiment of the present disclosure.

Referring to FIGS. 1A, 5, and 11, at operation 501, the electronic device 100 executes a voice communication function.

Thereafter, at operation 503, the electronic device 100 detects voice data through a microphone.

At operation 505, the electronic device 100 recognizes a user using the detected voice data. For example, the electronic device 100 acquires the voice data through the microphone, analyzes the acquired voice data, and recognizes the user. Herein, the electronic device 100 may recognize the user using well known voice recognition algorithms.

At operation 507, the electronic device 100 verifies whether the recognized user is identical to a previously registered child user. For example, the electronic device 100 recognizes the user using the detected voice data and verifies whether the recognized voice data of the user is identical to previously stored voice data of the child user. For example, as shown in FIG. 11, when a voice communication function 1101 is executed, the electronic device 100 may recognize a voice of the user through a microphone sensor and verify whether the recognized voice data 1103 of the user is identical to previously stored voice data of the child user.

If the electronic device 100 determines that the recognized user is identical to the previously registered child user at operation 507, then the electronic device 100 proceeds to operation 509, adjusts at least one output value automatically, and returns to operation 503. Herein, when the recognized user is determined as the child user, the electronic device 100 may turn down (e.g., reduce) a level of an output sound to be lowered by predetermined volume. The electronic device 100 may turn down (e.g., reduce) brightness of an output screen darkly by reducing an amount of current supplied to a display panel. The electronic device 100 may turn down (e.g., reduce) strength of output radio waves by reducing transmission power for signals to be transmitted to an external device.

In contrast, if the electronic device 100 determines that the recognized user is not identical to the previously registered child user at operation 507, the electronic device 100 proceeds to operation 511 at which the electronic device 100 performs a normal function thereof, and ends the algorithm of FIG. 5. Herein, the normal function of the electronic device 100 means a general function of the electronic device, which operates according to user input.

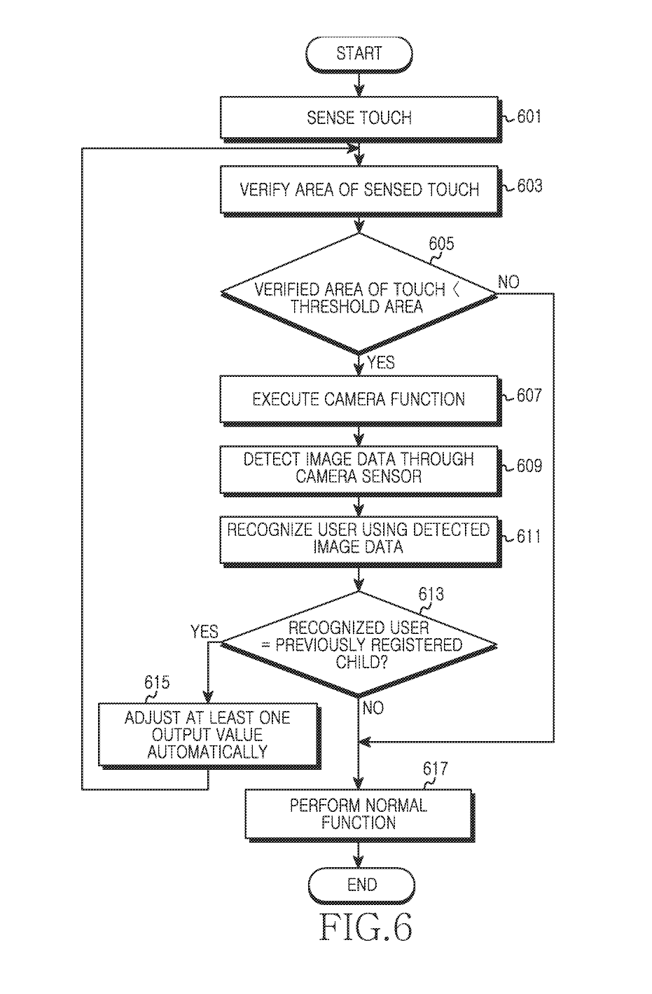

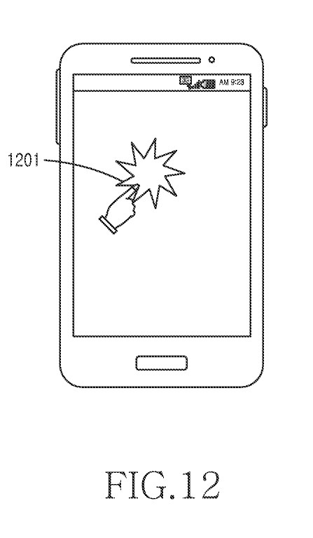

FIG. 6 is a flowchart illustrating a process of recognizing a user and adjusting at least one output value when detecting a touch in an electronic device according to an embodiment of the present disclosure. FIG. 12 illustrates an example to verify a size of a touch when detecting the touch in an electronic device according to an embodiment of the present disclosure.

Referring to FIGS. 1A, 6, and 12, at operation 601, the electronic device 100 detects touch.

At operation 603, the electronic device 100 verifies an area of the detected touch.

Thereafter, the electronic device 100 proceeds to operation 605 at which the electronic device 100 verifies whether the verified area of the touch is less than a previously stored threshold area of a touch. Herein, the threshold area may be preset in a design stage and be updated according to control of a user. For example, as shown in FIG. 12, when a touch 1201 is detected, the electronic device 100 may verify whether the detected area of the touch 1201 is less than the previously stored threshold area of a touch.

If the electronic device 100 determines that the verified area of the touch is less than the previously stored threshold area of the touch at operation 605, then the electronic device 100 proceeds to operation 607 at which the electronic device 100 executes a camera function. Herein, when the camera function is executed, the electronic device 100 may drive a camera without displaying a separate preview screen.

Thereafter, the electronic device 100 proceeds to operation 609 at which the electronic device 100 detects image data through a camera sensor.

At operation 611, the electronic device 100 recognizes a user using the detected image data. For example, the electronic device 100 acquires an image through the camera sensor and recognizes a face region of the user on the acquired image. Herein, the electronic device 100 may recognize a user face region using a well known video recognition algorithm and well known image recognition algorithms.

At operation 613, the electronic device 100 verifies whether the recognized user is identical to a previously registered child user. For example, the electronic device 100 may recognize a face of the user using the detected image data and verify whether the recognized face data is identical to previously stored data of the child user.

If the electronic device 100 determines that the recognized user is identical to the previously registered child user at operation 613, then the electronic device 100 proceeds to operation 615 at which the electronic device 100 adjusts at least one output value automatically and thereafter returns to operation 603. Herein, when the recognized user is determined to be the child user, the electronic device 100 may turn down (e.g., reduce) a level of an output sound to be lowered by predetermined volume. The electronic device 100 may turn down (e.g., reduce) brightness of an output screen darkly by reducing an amount of current supplied to a display panel. The electronic device 100 may turn down (e.g., reduce) strength of output radio waves by reducing transmission power for signals to be transmitted to an external device.

In contrast, when the electronic device 100 determines that the recognized user is not identical to the previously registered child user at operation 613, then the electronic device 100 proceeds to operation 617 at which the electronic device 100 performs a normal function thereof, and ends the algorithm of FIG. 6. Herein, the normal function of the electronic device 100 means a general function of the electronic device 100, which operates according to user input.

If the electronic device 100 determines that the verified area of the touch is greater than or equal to the previously stored threshold area of the touch at operation 605, then the electronic device 100 proceeds to operation 617 at which the electronic device 100 performs the normal function, and ends the algorithm of FIG. 6.

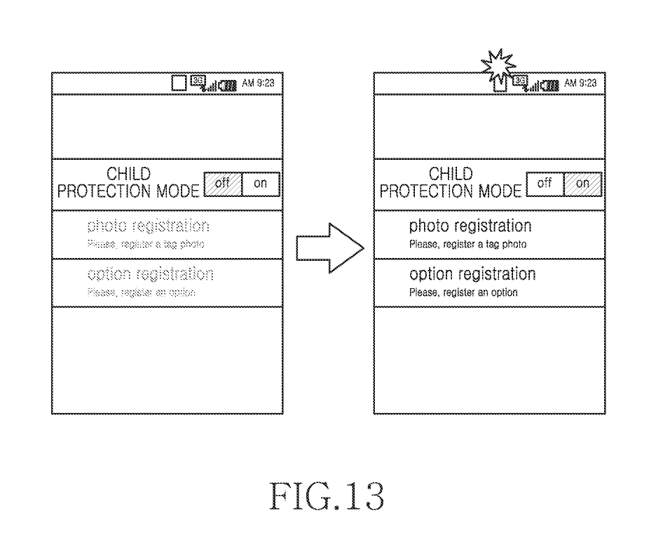

FIG. 13 illustrates an example to set a child protection menu in an electronic device according to an embodiment of the present disclosure.

Referring to FIG. 13, the child protection mode of the electronic device 100 may be turned on/off by setting of the user. Because at least one sensor is driven only when the child protection mode is turned on, the electronic device 100 may recognize the user.

Various embodiments and all function operations of the present disclosure may be executed by computer software, firmware, or hardware, or the combination of one or more of them, which include structures disclosed in the specification of the present disclosure and equivalent structures of them. Also, various embodiments of the present disclosure may be implemented by one or more computer program products, that is, one or more modules of computer program instructions, which are executed by data processing devices or are encoded on a computer readable medium for controlling operations of these devices.

The computer readable medium may be a non-transitory machine readable storage medium, a non-transitory machine readable storage board, a memory device, composition of materials which have an influence on a machine readable propagation stream, or the combination of one or more of them. The term “data processing device” includes a programmable processor, a computer, or all devices, apparatuses, and machines, including a multi-processor or a computer, for processing data. The devices may include codes for being added in hardware and generating execution environments for a corresponding computer program, for example, codes configuring processor firmware, a protocol stack, a database management system, an operating system, or the combination of one or more of them.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
detecting user related data using at least one sensor;
determining whether the user is a user who is previously registered in the electronic device using the detected user related data; and
automatically adjusting at least one output value of the electronic device when the user is determined as the user who is previously registered in the electronic device,
wherein at least the one sensor includes at least one of a camera sensor, a touch sensor, and a microphone sensor.

2. The method of claim 1, further comprising:
automatically stopping a call function of the electronic device when the user is determined to be the user who is previously registered in the electronic device.

3. The method of claim 1, wherein the determining of whether the user is the user who is previously registered in the electronic device using the detected user related data comprises:
comparing face data of the user detected through the camera sensor with face data of the user who is previously registered in the electronic device; and
determining the user to be the user who is previously registered in the electronic device when the detected face data of the user is identical to the face data of the user who is previously registered in the electronic device.

4. The method of claim 1, wherein the determining of whether the user is the user who is previously registered in the electronic device using the detected user related data comprises:
verifying whether voice data of the user detected through the microphone sensor is identical to voice data of the user who is previously registered in the electronic device; and
determining the user to be the user who is previously registered in the electronic device when the detected voice data of the user is identical to the voice data of the user who is previously registered in the electronic device.

5. The method of claim 1, wherein the determining of whether the user is the user who is previously registered in the electronic device using the detected user related data comprises:
comparing an area of a touch detected through the touch sensor with a previously stored threshold area; and
determining the user to be the user who is previously registered in the electronic device when the detected area of the touch is less than the previously stored threshold area.

6. The method of claim 1, wherein at least the one output value of the electronic device includes at least one of volume of a sound output through a speaker, brightness of a display panel, and transmission power of a signal output to an external device.

7. The method of claim 6, wherein the automatically adjusting of the at least the one output value of the electronic device when the user is determined as the user who is previously registered in the electronic device comprises:
reducing the volume of the sound output through the speaker by predetermined volume when the user is determined to be the user who is previously registered in the electronic device.

8. The method of claim 6, wherein the automatically adjusting of the at least the one output value of the electronic device when the user is determined as the user who is previously registered in the electronic device comprises:
reducing an amount of the current output to the display panel and reducing a brightness of a screen output through a display device when the user is determined to be the user who is previously registered in the electronic device.

9. The method of claim 6, wherein the automatically adjusting of the at least the one output value of the electronic device when the user is determined as the user who is previously registered in the electronic device comprises:
reducing the transmission power of the signal output to the external device by a predetermined level when the user is determined to be the user who is previously registered in the electronic device.

10. The method of claim 1, further comprising:
detecting user input in a waiting mode;
determining whether a user protection mode is preset; and
driving at least the one sensor when the user protection mode is set.

11. An electronic device comprising:
at least one processor;
a touch-sensitive display;
at least one sensor;
a memory; and
at least one program, each of the at least one program is stored in the memory and is executed by the at least one processor,
wherein each of the at least one program includes an instruction for detecting user related data using at least the one sensor, determining whether a user is a user who is previously registered in the electronic device using the detected user related data, and automatically adjusting at least one output value of the electronic device when the user is determined as the user who is previously registered in the electronic device, and
wherein the at least one sensor includes at least one of a camera sensor, a touch sensor, and a microphone sensor.

12. The electronic device of claim 11, wherein each of the at least one program further includes an instruction for automatically stopping a call function of the electronic device when the user is determined to be the user who is previously registered in the electronic device.

13. The electronic device of claim 11, wherein each of the at least one program includes an instruction for comparing face data of the user detected through the camera sensor with face data of the user who is previously registered in the electronic device, and for determining the user to be the user who is previously registered in the electronic device when the detected face data of the user is identical to the face data of the user who is previously registered in the electronic device.

14. The electronic device of claim 11, wherein each of the at least one program includes an instruction for verifying whether voice data of the user detected through the microphone sensor is identical to voice data of the user who is previously registered in the electronic device, and for determining the user to be the user who is previously registered in the electronic device when the detected voice data of the user is identical to the voice data of the user who is previously registered in the electronic device.

15. The electronic device of claim 11, wherein each of the at least one program includes an instruction for comparing an area of a touch detected through the touch sensor with a previously stored threshold area, and for determining the user to be the user who is previously registered in the electronic device when the detected area of the touch is less than the previously stored threshold area.

16. The electronic device of claim 11, wherein at least the one output value of the electronic device includes at least one of volume of a sound output through a speaker, brightness of a display panel, and transmission power of a signal output to an external device.

17. The electronic device of claim 16, wherein each of the at least one program includes an instruction for reducing the volume of the sound output through the speaker by predetermined volume when the user is determined to be the user who is previously registered in the electronic device.

18. The electronic device of claim 16, wherein each of the at least one program includes an instruction for reducing an amount of the current output to the display panel and reducing a brightness of a screen output through a display device when the user is determined to be the user who is previously registered in the electronic device.

19. The electronic device of claim 16, wherein each of the at least one program includes an instruction for reducing the transmission power of the signal output to the external device by a predetermined level when the user is determined to be the user who is previously registered in the electronic device.

20. The electronic device of claim 11, wherein each of the at least one program further includes an instruction for detecting user input in a waiting mode, determining whether a user protection mode is preset, and driving at least the one sensor when the user protection mode is set.
